(19) United States
(12) Patent Application Publication
(10) Pub. No.: US 2015/0212755 A1
(43) Pub. Date: Jul. 30, 2015

(54) METHOD OF MANAGING THROUGHPUT OF REDUNDANT ARRAY OF INDEPENDENT DISKS (RAID) GROUPS IN A SOLID STATE DISK ARRAY

(71) Applicant: Avalanche Technology, Inc., Fremont, CA (US)

(72) Inventor: Mehdi Asnaashari, Danville, CA (US)

(73) Assignee: Avalanche Technology, Inc., Fremont, CA (US)

(21) Appl. No.: 14/168,642

(22) Filed: Jan. 30, 2014

(51) Int. Cl. G06F 3/06

(52) U.S. Cl. CPC G06F 3/0629; G06F 3/0613; G06F 3/0688

(57) ABSTRACT

A method of writing to one or more solid state disks (SSDs) employed by a storage processor includes receiving a command, creating sub-commands from the command based on a granularity, and assigning the sub-commands to the one or more SSDs and creating a NVMe command structure for each sub-command.

### BACKGROUND OF THE INVENTION

1. Field of the Invention

This invention relates generally to redundant array independent disks (RAIDs) and particularly to RAIDs made of solid state disks.

2. Description of the Prior Art

There is no dispute that large storage is commonly employed for various reasons among which, by way of example, is for on-line transactions and searches. Redundant Array of independent disks (RAID), as its name suggests, is storage space of a large capacity and redundancy.

In some applications, solid state disks (SSDs) are grouped together to create a RAID group within a storage system that may support many RAID groups. Initially, a predetermined number of RAID group(s) are placed into a storage system and at a later time, additional RAID groups may be added to expand storage capacity and/or add increase throughput.

SSDs are typically costly. Further, they dissipate heat thereby affecting power consumption and management. Throughput is another factor in storage systems employing SSDs. To better describe the foregoing, a RAID group with a multitude of SSDs is placed in a storage system for maintaining large quantities of data. Additional space is typically made available for increasing storage capacity, as needed by a user, by adding more RAID groups. Each RAID group operates at a certain throughput and standard. For example, different generations of Peripheral Component Interconnect Express (PCIe)-compliant RAID groups may be employed for various applications. Further, different throughput rates may be required per RAID group. However, these requirements are typically limited to the RAID group's particular capability. That is, a RAID group that is only built to function as a GEN 2 RAID group cannot be made to operate as a GEN 3 RAID group. Similarly, a RAID group that is built to function at a certain speed cannot be employed to function at a higher speed.

Power consumption is typically affected based on throughput in that the higher the rate at which a RAID group operates, the higher its power consumption.

Currently, there is no mechanism for optimizing employment of RAID groups within a storage system. More specifically, cost, throughput, and power management are issues facing users of storage systems employing RAID groups.

Thus, there is a need for a storage system using RAIDs to have near optimal throughput and power management while reducing cost.

### SUMMARY OF THE INVENTION

Briefly, a method of managing redundant array of independent disk (RAID) groups in a storage system includes determining wear of each of the plurality of RAID groups, computing the weight for each of RAID groups based on the wear, and striping data across at least one of the RAID groups based on the weight of each of the RAID groups.

These and other objects and advantages of the invention will no doubt become apparent to those skilled in the art after having read the following detailed description of the various embodiments illustrated in the several figures of the drawing.

### IN THE DRAWINGS

FIG. 1 shows a storage system (or “appliance”) 8, in accordance with an embodiment of the invention.

FIG. 2 shows relevant portions of the storage system 8, in accordance with an embodiment of the system.

FIG. 3 shows relevant portions of the storage system 8, in accordance with another exemplary embodiment of the invention.

FIG. 4 shows a flow chart of a process performed by the CPU subsystem 14 when a new RAID group is added to the storage system, in accordance with methods of the invention.

### DETAILED DESCRIPTION OF THE VARIOUS EMBODIMENTS

In the following description of the embodiments, reference is made to the accompanying drawings that form a part hereof, and in which is shown by way of illustration of the specific embodiments in which the invention may be practiced. It is to be understood that other embodiments may be utilized because structural changes may be made without departing from the scope of the invention. It should be noted that the figures discussed herein are not drawn to scale and thicknesses of lines are not indicative of actual sizes.

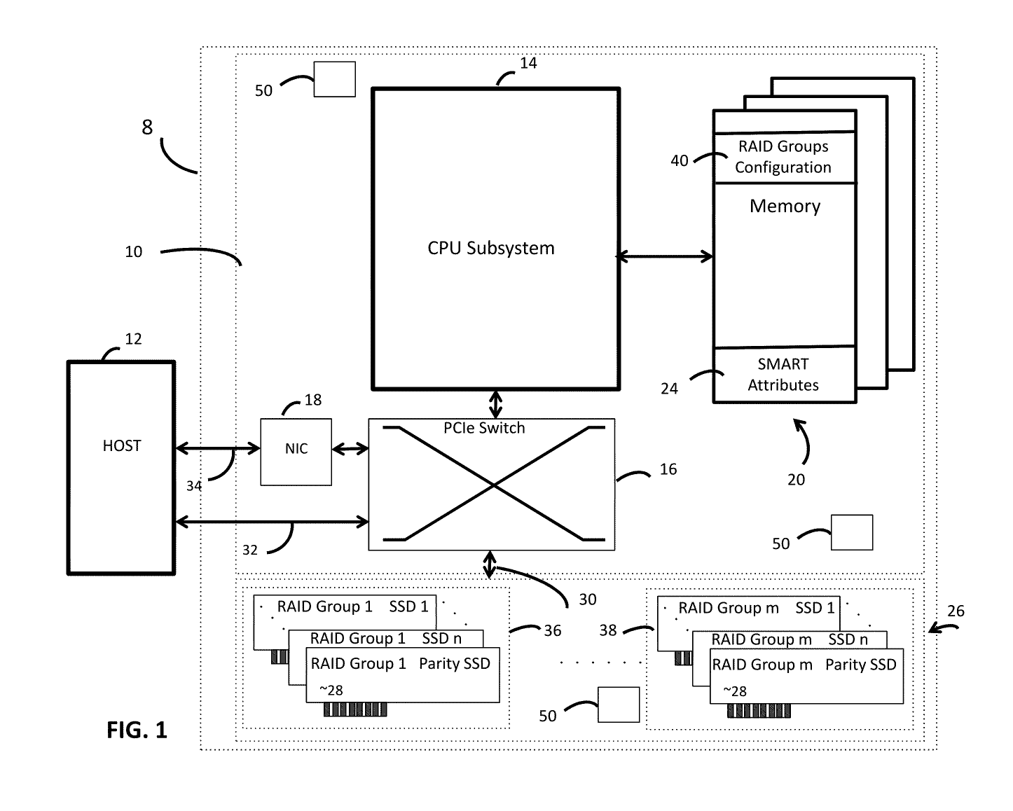

Referring now to FIG. 1, a storage system (or “appliance”) 8 is shown in accordance with an embodiment of the invention. The storage system 8 is shown to include storage processor 10 and redundant array of independent disks (RAID) groups 36 through 38, the latter defining a storage pool 26. The storage system 8 is shown coupled to a host 12. In an embodiment of the invention, the independent disks of the RAID groups 36 through 38 comprise of plurality of Peripheral Component Interconnect Express (PCIe) solid state disks (SSD) 28. Storage system 8 is further shown to include one or more temperature sensors 50 at various critical locations where temperature information can be used to effectuate power management. In an embodiment of the invention, SSD 28 may include one or more temperature sensors 50.

In the embodiment of FIG. 1, a temperature sensor 50 is shown in the storage pool 26 and a couple of temperature sensors 50 are shown in the storage processor 10. It is understood that these are merely exemplary locations of the sensor 50 and other critical locations within the storage system 8 are contemplated. Further examples of such locations, without limitation, are in one or more of the SSDs of the storage pool 26. Additionally, any suitable number of sensors 50 may be employed.

PCIe or PCI Express is a high speed serial bus standard designed for high throughput systems with lower Input/Output (IO) pin count and better throughput scaling. The PCIe link between two devices can currently consist of anywhere from 1 to 32 lanes. Throughput of a PCIe-based system scales with overall link width. The link or number of the PCIe lanes between two connected devices are automatically negotiated during device initialization and can be restricted by either device to the highest mutually supported lane count and PCIe generation. PCIe standard allows devices to have anywhere from 1 lane, for cost sensitive applications with lower throughput, to 32 lanes for throughput critical applications. PCIe 3.0 is the latest standard in production with PCIe 2.0 and 1.1 still being widely employed. Data transfer rate for PCIe 1.1, PCIe 2.0, and PCIe 3.0 is 2.5 gigabits transfer per second (GT/s), 5 gigabits transfer per second (GT/s), and 8 gigabits transfer per second (GT/s) respectively. Throughput of a PCIe device with 8 lanes of PCIe 1.1, PCIe 2.0, or PCIe 3.0 is 2,000 megabytes per second (MB/s), 4,000 MB/s, or 8,000 MB/s respectively.

The storage processor 10 is shown to include a CPU subsystem 14, a PCIe switch 16, a network interface card (NIC) 18, and memory 20. The memory 20 is shown to maintain RAID group configuration information 40 and self-monitoring analysis and reporting technology (SMART) attributes 24. The storage processor 10 is further shown to include an interface 34 and an interface 32. The RAID group configuration 40 is information regarding characteristics of the RAID groups of the storage pool 26. This information includes the generation type of the RAID group, the rate at which the RAID group is capable of operating, the PCIe lanes the RAID group can support in addition with other types of information. The RAID group configuration 40 also includes information regarding the current status of RAID groups, for example, the rate at which a RAID group is currently operating, the currently generation of the RAID group, the PCIe lanes currently being used by a RAID group and the like.

Referring still to FIG. 1, the host 12 is shown coupled to the NIC 18 through the interface 34 and is optionally coupled to the PCIe switch 16 through the interface 32. The PCIe switch 16 is shown coupled to the storage pool 26 through PCIe interface 30. The storage pool 26 is shown to include ‘m’ RAID groups 36 through 28 with each RAID group consisting of ‘n’ number of PCIe SSDs 28 and a parity SSDs, “m” and “n” being integer values. The PCIe switch 16 is further shown coupled to the NIC 18 and the CPU subsystem 14. The CPU subsystem 14 is shown coupled to the memory 20. It is understood that the memory 20 may and typically does store additional information, not depicted in FIG. 1.

In an embodiment of the invention, parts or all of the memory 20 is volatile, such as, without limitation, dynamic random access memory (DRAM). In other embodiments, part or all of the memory 20 is non-volatile, such as and without limitation flash, magnetic random access memory (MRAM), spin transfer torque magnetic random access memory (STTMRAM), resistive random access memory (RRAM), or phase change memory (PCM). In still other embodiments, the memory 20 is made of both volatile and non-volatile memory.

The storage system 8 comprises of one or more RAID groups 36 through 38. A RAID group uses multiple disks that appear to be a single device to a user who may wish to increase storage capacity, improve overall throughput, and provide fault tolerance. The storage system 8 is further operable with as few as one RAID group. Additional RAID groups may be added as required later when the existing RAID groups in the system are maximally utilized and additional capacity is required. When additional RAID groups are added to the storage system 8, the throughput of the storage system 8 increases substantially since there are now additional SSDs for storing data. The process of saving segments of data across a number of SSDs is typically referred to as striping.

Storage system 8 may employ different RAID architectures depending on the desired balance between throughput and fault tolerance. These architectures are called “levels”. Level 0, for example, is a striped disk array without fault tolerance which indicates that the SSDs do not use parity. Level 4 is a striped disk array with SSDs having dedicated parity and level 5 is a striped disk array with distributed parity across the SSDs. Level 6 is similar to level 5 with the exception of having double parity distributed across the SSDs.

During operation, the host 12 issues a read or a write command, along with data in the case of the latter. Information from the host is normally transferred between the host 12 and the processor 10 through the interfaces 32 and/or 34. For example, information is transferred through the interface 34 between the processor 10 and the NIC 18. Information between the host 12 and the PCIe switch 16 is transferred using the interface 34 and under the direction of the of the CPU subsystem 14.

In the case where data is to be stored, i.e. a write operation is consummated, the CPU subsystem 14 receives the write command and accompanying data, from the host 12, through the PCIe switch 16, for storage in the storage pool 26, under the direction of the CPU subsystem 14.

Under the direction of the CPU subsystem 14, the received data is eventually saved in the memory 20. The storage processor 10 or the CPU subsystem 14 then stripes the data across the SSDs 28 of RAID groups 36 through 38. The throughput of the storage system 8, at least in part, depends on the number of SSDs in the system hence the number of RAID groups. As RAID groups are added to the storage system 8, the throughput of the storage system 8 also increases because the storage processor 10 can stripe data across more SSDs. A storage system with only one RAID group will most likely have half the throughput of a storage system with two RAID groups if all of the RAID groups are configured the same.

In order to increase the throughput of a partially populated storage system, the populated RAID groups have to operate at a higher throughput to compensate for the missing RAID groups in the storage system thereby requiring the RAID groups to be configurable to operate at different throughputs based on the number of RAID groups.

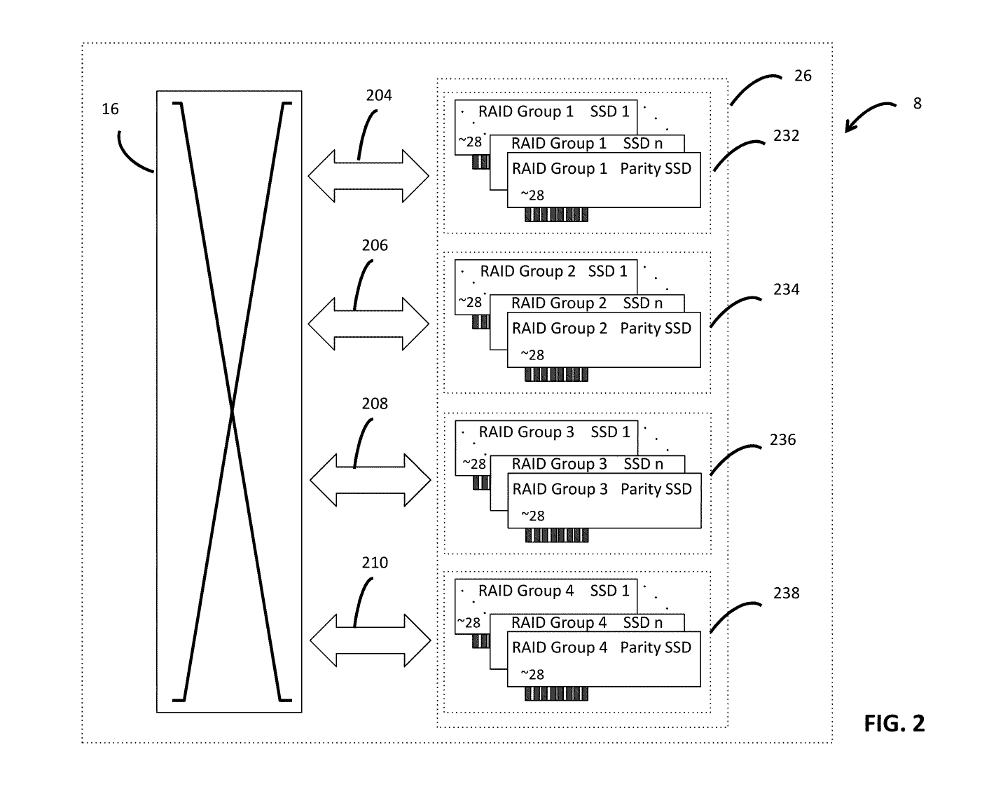

Referring now to FIG. 2, relevant portions of the storage system 8 are shown in accordance with an embodiment of the invention. More specifically, the storage system 8 is shown to include an example of a storage pool 26 in accordance with an embodiment of the invention along with a PCIe switch 16 and RAID interfaces 204, 206, 208, and 210. The storage pool 26 is shown to include 4 RAID groups 232, 234, 236, and 238 with RAID group 1 being connected to the PCIe switch 16 through RAID interface 204, RAID group 2 being connected to the PCIe switch 16 through RAID interface 206, and so on.

As mentioned earlier, even though the storage system 8 supports a plurality of RAID groups, it is operable with one or more RAID groups. New RAID groups are added to existing RAID groups when required. During an exemplary operation, the storage system 8 employs below a certain number of RAID groups, its throughput is not at its optimum since there is not enough RAID groups, thus, there is a shortage of SSDs to stripe data across. To increase the throughput of the storage system 8 with partially populated RAID groups, the SSDs of the RAID groups have to be configurable to provide different throughput levels. When the storage system 8 is not fully populated, the SSDs of the RAID groups are configured to operate at a higher throughput and when additional RAID groups are added, the RAID groups can be reconfigured to operate at a lower throughput. The throughput of the SSDs therefore depends on the number of RAID groups in the storage system.

In most storage systems, the throughput of the system mostly depends on the number of RAID groups in the storage system and the number of SSDs within a RAID group. The throughput of the storage system 8 scales up with the number of RAID groups up to a certain point and saturates thereafter. It is desirable to operate the SSDs at a higher level of throughput when the storage system is not fully populated such that the storage system can provide close to its highest throughput. However, it is not desirable to operate the SSDs at a higher throughput when the higher throughput does not contribute to overall throughput of the storage system 8. A factor that is taken into account is that the SSDs 28 consume more power and dissipate more heat when they operate at the higher throughput.

Referring back to FIG. 2, the storage system 8 is capable of supporting four RAID groups 232, 234, 236, and 238 that are all shown coupled to the PCIe switch 16 through the RAID interfaces 204, 206, 208 and 210, respectively. When the storage system 8 is operating with only one RAID group; for example RAID group 232, SSDs 28 of the RAID group 232 can be configured to operate at their highest throughput.

In some embodiments, each of the RAID interfaces is an aggregate of all of the PCIe lanes of a RAID group. In storage systems requiring higher throughput, typically, an additional number of PCIe lanes is employed; for example 4-lane (X4) or 8-lane (X8), and/or a higher PCIe generation is employed; such as PCIe 2.0 or PCIe 3.0 This requires at least some of the RAID groups in the storage system 8 to be configurable and have the means to support higher throughput than the remaining RAID groups.

When a RAID group; such as RAID group 234 in FIG. 2, is added to the storage system 8, the throughput of the SSDs of the RAID groups 232 and 234 can be lowered by reconfiguring them to a lower number of lanes; for example 4-lane or 2-lane, or lower PCIe generation; for example PCIe 2.0 or PCIe 1.1, or a combination of both. For the reconfiguration to take effect between the switch 16 and the SSDs of a RAID group of the storage pool 26; these devices go through a link-training process. Because the number of SSDs has doubled, the storage processor 10 can now stripe the data across the SSDs in both RAID groups, i.e. RAID group 232 and RAID group 234. As such, the storage system 8 will operate at a higher throughput than required if the SSDs are operated at their highest throughput level, otherwise, the SSDs will idle frequently, a less interesting result.

Accordingly, not all of the individual SSDs in a RAID group need operate at their maximum throughput to provide the throughput that the storage system 8 requires. Each SSD in the RAID group can operate at a lower throughput and the storage system 8 will still deliver the requisite throughput.

Operating each SSD in a RAID group at its maximum throughput will also unnecessarily generate more heat, which has to be dissipated by the storage system 8, without contributing to the throughput of the storage system. Most storage systems 8 are designed to dissipate a predetermined amount of heat when fully configured, meaning employing a maximum number of RAID groups, and enjoying certain throughput.

In an exemplary method of the invention, a predetermined amount of heat dissipation is allocated per SSD 28 when the storage system 8 is fully populated. In a not-fully populated storage system, it is acceptable and desirable to operate the SSDs in the RAID groups at a higher throughput than would otherwise be the case if the storage system was fully populated. More specifically, each SSD consumes more energy and generates more heat since the heat dissipation mechanism of the storage system is generally designed for a fully-populated storage system.

As the number of RAID groups in the storage system 8 increases and approaches the maximum number of the RAID groups the system can support, operating the SSDs in the RAID groups at their highest throughput will not equate to a higher system throughput. The extra heat that is generated will make the storage system 8 overheat thereby preventing proper function of the storage system. The storage processor 10 reconfigures the throughput of SSDs in each RAID group based on predetermined system throughput requirements, heat dissipation for which the storage system 8 is designed, and the number of RAID groups in the storage system.

In one embodiment of the invention, the throughput of the RAID groups is based on the number of SSDs in the RAID groups and the throughput of the individual SSDs. Throughput of the SSDs is configured through the number of PCIe lanes such as X2, X4, or by 8, and the PCIe generation such as PCIe 1.1, PCIe 2.0, or PCIe 3.0. In an embodiment of the invention, the storage processor 10 re-configures the PCIe SSDs 28 configuration register(s) by changing the width of the bus (the number of PCIe lanes) or PCIe generation or combination of both. The storage processor 10 will re-initialize the SSDs 28 or the SSDs 28 on their own initiative re-initialize themselves in response to re-configuration to re-initiates the link training between the SSDs 28 in the RAID group and the PCIe switch 16 to the new highest mutually supported lane count and PCIe generation. In another embodiment, the storage processor re-configures the PCIe switch 16 registers associated with the RAID interface that is coupled to the SSDs of the RAID group; such as the RAID group 232 and the RAID interface 204. Subsequently, the storage processor 10 will re-initialize the SSDs 28 or the SSDs 28 on their own initiative re-initialize themselves in response to re-configuration to re-initiates link training between the SSDs 28 in the RAID group and the PCIe switch 16 to the new highest mutually supported lane count and PCIe generation.

In another embodiment of the invention, all the RAID groups do not have to have the capability of operating at what is considered a high throughput. Rather, only one of the RAID groups needs to be capable of operating at the highest throughput and a RAID interface with the highest number of lanes and generation. In this case, controllers of the SSDs in the one RAID group with the capability of operating at its highest throughput needs to support the maximum number of PCIe lanes and PCIe generations to achieve the required throughput of the storage system. The throughput of the rest of the RAID groups need not be as high as that of the first RAID group and in fact their throughput can be reduced over time. For example, the second RAID group can have a lower throughput than the first RAID group and the third RAID group can have a lower throughput than the second RAID group and so forth.

Furthermore, the first RAID group can operate at the higher throughputs in compare to the second RAID group or the third RAID group. Lower throughputs of the second RAID group or the third RAID groups translates to a lower number of PCIe lanes and inexpensive SSD controllers as well as considerably reduced cost of the storage system 8.

In the example of FIG. 2, the SSDs in the first RAID group 232 may support 8-lane of PCIe 2.0 with each SSD having a maximum throughput of 500 MB/s. If there are 8 SSDs per RAID group, the total throughput of the RAID group 232 is 4,000 MB/s. The SSDs in the second RAID group 234 can, for example, support a 4-lane of PCIe 2.0 having a throughput of 250 MB/s. Upon the addition of the second RAID group to the storage system, which includes the existing first RAID group, the first RAID group is reconfigured to have 4 lanes instead of 8 lanes. The storage system 8 now has two RAID groups 232 and 234, totaling 16 PCIe SSDs 28, with each PCIe SSD having 4 lanes of PCIe 2.0. The total throughput of the storage system 8 is 16×250 MB/s=4000 MB/s. As noticed, the storage system maintains a throughput of 4,000 MB/sec similar to that of the configuration with only the first RAID group except that, in the case of the former, the interface is now running with only 4 lanes per SSD. As such, each SSD consumes considerably less power and dissipates less heat in comparison to the 8-lane SSD configuration. Once RAID groups 236 and 238 are added to the storage system 8, which includes the existing RAID groups 232 and 234, the SSDs in the RAID groups 232 and 234 can be reconfigured to be 2-lane and PCIe 2.0 types of SSDs. The storage system 8 now has four RAID groups with 8 SSDs per RAID group and each SSD having a throughput of 125 MB/s.

Referring still to the example of FIG. 2, the RAID interface 202 is a 8-lane PCIe 2.0 per SSD, the RAID interface 204 is a 4-lane PCIe 2.0 per each SSD and the RAID interfaces 206 and 208 are 2-lane and PCIe 2.0 per each SSD. In this embodiment of the invention, total number of PCIe lanes in RAID interface 202 is (8 PCIe lanes times 8 SSDs in first RAID group)+(4 PCIe lanes times 8 SSDs in second RAID group)+2 times (2 PCIe lanes times 8 SSDs)=128 PCIe 2.0 lanes.

In the example of FIG. 2, if all SSDs of all RAID groups had 8 lanes of PCIe 2.0, the total number of PCIe lanes to support a fully-populated storage system would be 256 lanes, which is obviously substantially larger than 128 lanes that are required in a storage system where the throughput of some of the RAID groups is lower than the maximum throughput. This example is inferior compared to that which is provided above. PCIe switches with a greater number of PCIe lanes are more costly than PCIe switches with fewer number of PCIe lanes. Additionally, the complexity of the layout and design of the printed circuit board (PCB) substantially increases as the number of the PCIe lanes increases.

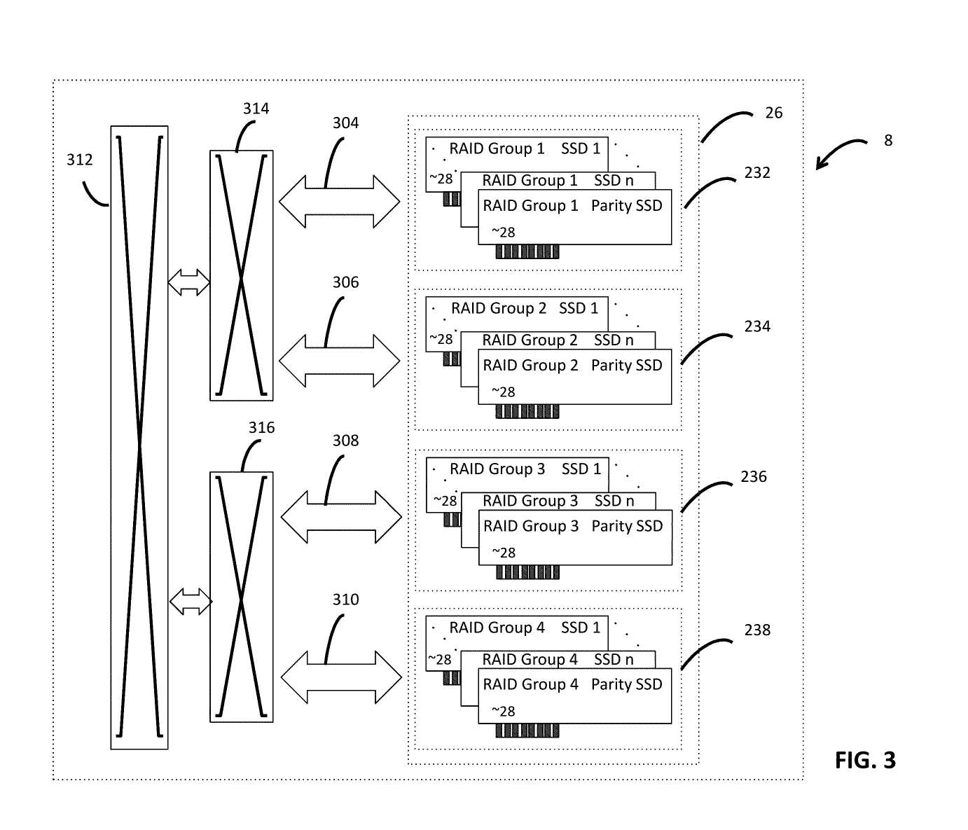

Referring now to FIG. 3, relevant portions of the storage system 8 are shown in accordance with another exemplary embodiment of the invention. More specifically, the storage system 8 is shown to include cascaded PCIe switches 312, 314, and 316. The storage pool 26 is shown to include the 4 RAID groups 232, 234, 236, 238, respectively. The RAID group 232 and RAID group 232 are shown coupled to the PCIe switch 314 through RAID interface 304, and 306, respectively. RAID group 236 and RAID group 238 are coupled to the PCIe switch 316 through RAID interface 308 and 310, respectively.

In one embodiment of this invention, RAID group 232 has the highest throughput relative to the remaining RAID groups and as such supports the maximum number of PCIe lanes and/or the highest PCIe generation. RAID group 234 has a lower throughput in comparison to RAID group 232 but it has a higher throughput than that of the RAID groups 236 and 238. RAID groups 236 and 238 have lower throughputs relative to that of the RAID groups 232 and 234 and thus have a lower number of PCIe lanes and/or a lower PCIe generation.

In an embodiment of the invention, PCIe switch 314 connected to the higher-throughput RAID groups 232 and 234 is a PCIe 2.0 switch and the PCIe switch 316 connected to the lower-throughput RAID groups 236 and 238 is a PCIe 1.1 type of switch. PCIe 1.1 switches cost substantially less than PCIe 2.0 switches which reduces the cost of storage system 8 while maintaining the storage system 8 required throughput.

In the example of FIG. 3, the storage system 8 throughput requirement can be about 4,000 MB/s. With 8 SSDs per RAID group, each SSD in the RAID group 232 should be an 8-lane of PCIe 2.0 with each SSD having a maximum throughput of 500 MB/s and the RAID group 232 having a total throughput of 4,000 MB/s. The RAID interface 304, coupling the PCIe switch 314 to the 8 SSDs of RAID group 232, requires 64 lanes of PCIe 2.0. The SSDs in the RAID group 234 do not need to have 8-lane PCIe and can for example have only 4-lanes of PCIe 2.0 with a throughput of 250 MB/s, assuming the RAID group 234 has a total throughput of 2,000 MB/s. The RAID interface 306, coupling the PCIe switch 314 to the 8 SSDs of RAID group 234, requires only 32 lanes of PCIe 2.0. When the RAID group 234 is added to the storage system 8 in addition to the existing RAID group 232, the RAID group 232 is reconfigured to be a 4-lane PCIe rather than an 8-lane PCIe. Total throughput of the storage system 8 remains at 4,000 MB/s with each RAID group having a throughput of 2,000 MB/s. Each SSD in the RAID group 236 and the RAID group 238 can, for example, only support 2 lanes of PCIe 2.0 or a 4-lane of PCIe 1.1 with a throughput of 125 MB/s assuming the RAID groups 236 and 238 each has a total throughput of 1000 MB/s. The RAID interfaces 308 and 310, coupling the PCIe switch 316 to the RAID groups 236 and 238, each requires either 16 lanes of PCIe 2.0 or 32 lanes of PCIe 1.1. When the RAID groups 236 and 238 are added to the storage system 8, in addition to the existing RAID groups 232 and 234, the RAID groups 236 and 238 are each reconfigured to be 2-lane PCIe 2.0 or 4-lane PCIe 1.1. The total throughput of the storage system 8 remains at 4000 MB/s with each of the 4 RAID groups having a throughput of 1000 MB/s.

In this example, the PCIe switch 314 is a 2.0 switch but the PCIe switch 316 can either be a PCIe 1.1 or a PCIe 2.0 switch. PCIe 1.1 switches cost substantially less than their PCIe 2.0 switches. Furthermore, the number of PCIe lanes or the PCIe generation requirements for the lower throughput RAID groups are substantially less than that for the higher throughput RAID groups which also translates to lower cost SSD controllers as well as a less complex mother board design.

In one embodiment of the invention, the storage system 8 and/or the SSDs of the RAID groups may have temperature sensors scattered throughout the critical sections of the system and SSDs. The storage processor 10 may identify the temperature of the RAID groups in the storage system 8 by periodically reading the sensors and reconfiguring the RAID groups accordingly. If, for example, one or more the RAID groups are operating at a temperature that is higher than a predetermined threshold, set based on a heat budget, the storage processor 10 will reconfigure these over-heated RAID groups to operate at a lower throughput. Operating at a lower throughput causes the SSDs of these RAID groups to dissipate less heat and eventually reach a temperature that is below their respective thresholds.

In one embodiment, once the temperature of the over-heated RAID groups operating at a lower throughput is below the threshold, the RAID groups may be reconfigured back to their throughput prior to the time their throughput was lowered.

In another embodiment of the invention, the storage processor 10 may utilize the RAID groups operating at a higher temperature less often than the RAID groups operating at a lower temperature by scheduling less commands for the particular RAID group or scheduling commands to the particular RAID groups less often. In One embodiment, the storage processor 10 may only schedule read commands and no write commands to the RAID groups operating at temperature above their respective threshold.

In yet another embodiment of the invention, the storage processor 10 may identify the temperature of the RAID groups in the storage system 8 by reading the self-monitoring analysis and reporting technology (SMART) attributes and specifically the ‘Temperature’ attribute of the SSDs in the RAID groups in determining the temperature of the RAID groups. SMART is a standard interface protocol that allows a disk to check its status and report it to a host system. SMART information consists of ‘attributes’ each one of which describes some particular aspect of the drive condition such as ‘temperature’. Each drive manufacturer may define its own set of attributes but they mostly try to adhere to the standard for interoperability.

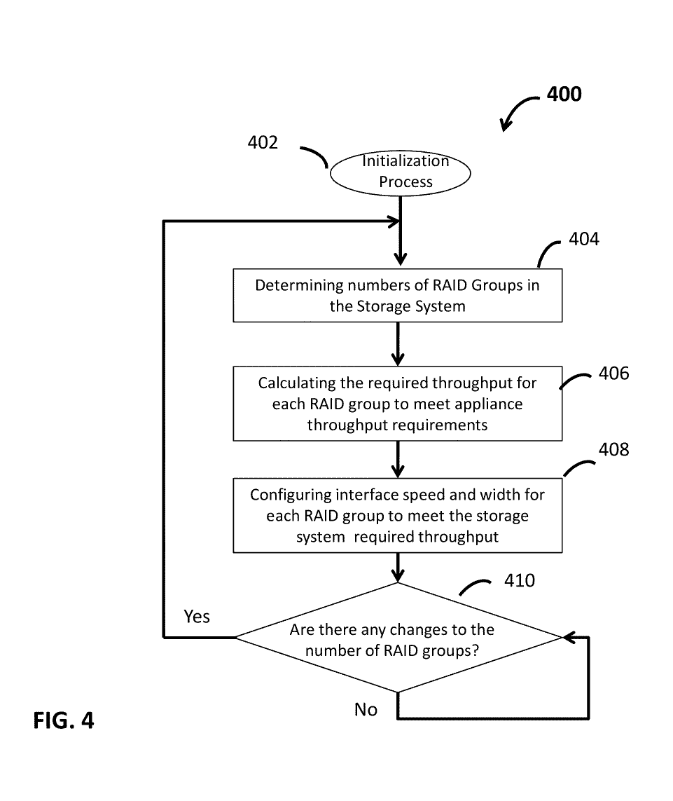

FIG. 4 shows a flow chart 400 of the relevant steps performed when a new RAID group is added to the storage pool 26, in accordance with a method of the invention. At step 402. Next, at step 404, the number of RAID groups in the storage system is determined. At step 406, the throughput required from each RAID group to meet the overall throughput of the storage system 8 is calculated. Next, at step 408, the storage processor 10 configures the interface speed (PCIe generation) and width (number of PCIe lanes) for each RAID groups based on the number of the RAID groups in the storage system 8 and required throughput. Next at step 410, determination is made as to whether or not there have been any changes to the number of RAID groups in the storage system 8. If there have been changes, i.e. the determination yields ‘Yes’, the process proceeds to step 404 where the RAID group initialization process repeats itself, from step 404 on, by re-determining the number of RAID groups, re-calculating the required throughput for each RAID groups and each SSD of the RAID groups, and re-configuring each RAID groups. If the determination yields no change, i.e. ‘No’, the process waits until there is a change. That is, periodically, the system 8 checks for additional RAID groups and proceeds with steps generally outlined in FIG. 4.

Although the invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

What is claims is:

1. A method of managing throughput of redundant array of independent disk (RAID) groups in a storage system, the method comprising:
determining the number of RAID groups located within the storage system of one or more of the RAID groups, a RAID group comprising multiple disks that appear to be a single device to a user, each disk having associated therewith a configurable plurality of PCIe lanes;
calculating throughput requirements for each RAID group based on the determined number of RAID groups;
configuring each of the RAID groups to meet the calculated throughput requirements;
configuring the one or more RAID groups based on the determined number of one or more RAID groups;
adding one or more RAID groups to the storage system; and
upon adding one or more RAID groups, re-configuring the PCIe lanes of at least one of the disks of the currently-employed one or more RAID groups.

2. The method of managing throughput, as recited in claim 1, wherein the disks are SSDs and wherein the calculating step includes determining PCIe generation and number of PCIe lanes for each SSD.

3. The method of managing throughput, as recited in claim 1, wherein the disks are SSDs and wherein the configuring step is configuring the SSDs.

4. The method of managing throughput, as recited in claim 3, wherein the configuring step further includes initializing the SSDs.

5. The method of managing throughput, as recited in claim 4, wherein the initializing step further includes initiating a link training.

6. The method of managing throughput, as recited in claim 1, wherein the storage system further includes one or more switches and wherein the configuring step includes configuring the one or more switches.

7. The method of managing throughput, as recited in claim 6, wherein the disks are SSDs and wherein the configuring step further includes initializing the SSDs.

8. The method of managing throughput, as recited in claim 7, wherein the initializing step further includes initiating a link training.

9. The method of managing throughput, as recited in claim 1, wherein the determining the throughput step is based on throughput requirements of the storage system.

10. (canceled)

11. The method of managing throughput, as recited in claim 1, wherein the configuring step determines a number of PCIe lanes supported by the one or more RAID groups and based on the determining the number of PCIe lanes, changes the number of PCIe lanes of the disks of the one or more RAID groups.

12. The method of managing throughput, as recited in claim 11, wherein the configuring step further includes determining a PCIe generation of the disks of the one or more RAID groups and based upon the determining the PCIe generation, changing the PCIe generation of the one or more RAID groups.

13. The method of managing throughput, as recited in claim 1, wherein the disks are SSDs, and further wherein the configuring step includes determining a PCIe generation of the SSDs of the one or more RAID groups and based upon the determining the PCIe generation, changing the PCIe generation of the one or more RAID groups.

14. (canceled)

15. The method of managing throughput, as recited claim 1, wherein upon adding at least one other RAID group to the one or more RAID groups, re-determining the number of RAID groups in the storage system.

16. The method of managing throughput, as recited claim 15, further including re-calculating throughput requirements for each RAID group of the one or more RAID groups based on the re-determined number of RAID groups.

17. The method of managing throughput, as recited claim 16, further including re-configuring each of the RAID groups to meet the calculated throughput requirements.

18. The method of managing throughput, as recited in claim 1, wherein the calculating step further includes measuring the temperature of the one or more RAID groups.

19. The method of managing throughput, as recited in claim 18, wherein the storage system includes temperature sensors and the method of managing further includes periodically reading the temperature sensors by the storage processor.

20. The method of managing throughput, as recited in claim 18, wherein the storage processor re-configures the one or more RAID groups based on the measured temperature.

21. The method of managing throughput, as recited in claim 20, wherein the one or more RAID groups include SSDs and wherein the SSDs include temperature sensors and the method of managing throughput further includes periodically reading the temperature sensors by the storage processor.

22. The method of managing throughput, as recited in claim 21, further including the storage processor re-configuring the SSDs of the one or more RAID groups based on the read temperature.

23. The method of managing throughput, as recited in claim 22, wherein the one or more RAID groups operate at or below a threshold temperature, and the re-configuring further includes lowering the throughput of the one or more RAID groups operating at a temperature above their respective threshold temperature.

24. The method of managing throughput, as recited in claim 21, wherein the one or more RAID groups operate at or below a threshold temperature and further wherein the method of managing throughput further includes the utilizing the one or more RAID groups being operated at a temperature above their respective threshold less often in the future.

25. The method of managing throughput, as recited in claim 21, wherein the one or more RAID groups operate at or below a threshold temperature and further wherein the storage processor utilizes the one or more RAID groups operating at a temperature above their respective threshold temperature only for read operations.

26. (canceled)

27. (canceled)

28. A method of configuring redundant array of independent disk (RAID) groups in a storage system, the method comprising:
determining the number of the one or more RAID groups located within a storage system and currently being employed by the storage system, each of the one or more RAID groups comprising multiple disks appearing to be a single device to a user, each disk having associated therewith a configurable plurality of PCIe lanes;
operating the one or more RAID groups based on the determined number of one or more RAID groups,
wherein the number of the one or more RAID groups being less than the number of RAID groups the storage system is capable of employing while maximizing throughput of the storage system;
configuring the one or more RAID groups based on the determined number of one or more RAID groups;
adding one or more RAID groups to the storage system; and
upon adding one or more RAID groups, re-configuring the PCIe lanes of at least one of the disks of the currently-employed one or more RAID groups.

29. The method of configuring, as recited in claim 28, further including configuring the one or more RAID groups based on the determined number of one or more RAID groups.

30. (canceled)

31. The method of managing throughput, as recited in claim 1, further including maintaining configuration information of characteristics of the RAID groups in a memory.

32. The method of managing throughput, as recited in claim 31, wherein the configuration information includes a generation type of the RAID groups, a rate at which the RAID groups are capable of operating, or Peripheral Component Interconnect Express (PCIe) lanes each RAID group is capable of supporting, the rate at which each RAID group is currently operating, the current generation of each RAID group, or the PCIe lanes currently being used by each RAID group.

33. The method of configuring, as recited in claim 28, wherein the re-configuring the PCIe lanes includes reducing the number of PCIe lanes.

34. The method of managing throughput, as recited in claim 1, wherein the re-configuring the PCIe lanes includes reducing the number of PCIe lanes.
